(19) United States
(12) Patent Application Publication
(10) Pub. No.: US 2010/0123295 A1
(43) Pub. Date: May 20, 2010

(54) Skateboard

(75) Inventor: Sergio Landau, Laguna Niguel, CA (US)

Correspondence Address: KOLISCH HARTWELL, P.C., 200 PACIFIC BUILDING, 520 SW YAMHILL STREET, PORTLAND, OR, 97204, US

(73) Assignee: Pardau, LLC, Laguna Niguel, CA (US)

(21) Appl. No.: 12/272,698

(22) Filed: Nov. 17, 2008

Related U.S. Application Data
(60) Provisional application No. 61/078,423, filed on Nov. 17, 2008.

(51) Int. Cl. B62M 1/00

(52) U.S. Cl. 280/87.042

(57) ABSTRACT

A skateboard is provided with a deck providing a support platform for the user, a front and rear wheel sets and trucks coupled to the deck. The support platform may include a central portion and raised front and rear portions. The front and rear portions may angle upwardly from the central portion, and then angle downwardly. The trucks may be coupled to the deck at the downwardly angled portions. The front and rear trucks may each include a pair of torsion springs alongside a kingpin. A foot-operated brake may be mounted to the rear portion of the support platform. The deck may include a hinged portion located between the front and rear portions with a handle located in the hinged portion of the deck.

### CROSS-REFERENCE TO RELATED APPLICATIONS

This application claims priority under 35 U.S.C. §119(e) to U.S. Provisional Patent Application Ser. No. 61/078,423 filed on Jul. 6, 2008 and is entitled “SKATEBOARD.” The complete disclosure of the above-identified patent application is hereby incorporated by reference for all purposes.

### BACKGROUND

Skateboards are generally provided with a deck and two pairs of wheels, with front and rear trucks each coupling one pair of the wheels to the deck. The skateboard rolls as propelled by a rider and/or in a downhill direction, and the trucks steer the wheels in the direction that the rider tilts the deck. Typical skateboards are suited only to low speed operations because of the lack of stability from the small size of the wheels and the placement of the deck over the wheels. Some skateboards, such as longboards, are more suited to cruising operation, and may be more suitable for higher speeds and are used for transportation. However, even longboards usually lack a braking mechanism, which further detracts from high speed operation. Skateboards are also cumbersome to carry and to stow due to their size and shape.

### SUMMARY

The disclosed skateboard includes a deck with an upper surface that is close in elevation to the axes of rotation of the wheels. For example, the upper surface may be slightly above, generally level with, or below the axes of rotation of the wheels, or may be at another elevation as suited to a desired application of the skateboard. The deck may have a uniform elevation, or may include portions at different elevations. For example, the deck may include a central portion at a low elevation and raised front and/or rear portions to facilitate mounting of trucks beneath the deck while maintaining a low elevation for the central portion of the deck.

The skateboard of the present disclosure includes trucks that preferably are mounted to the deck and each truck connects an axle to the deck so that the wheels mounted on the axle are steered by a tilting of the deck. For example, each truck may be mounted by a kingpin coupled to the deck at an angle offset from vertical, with a pair of torsion springs, or other cushions or shock absorbers alongside the kingpin biasing the wheels to a neutral steering position. The angled mount of the kingpin causes the wheels to diverge from the neutral position when the deck is tilted. A stop may be provided adjacent the trucks to limit the divergence of the wheels from the neutral position.

The angled mount may be provided by locating a hole for each kingpin in an angled portion of the deck, for example, in front and rear downwardly-angled portions. The kingpin hole may be aligned with other holes or cavities in the deck to facilitate a molded construction for the deck.

The skateboard may also include a brake mounted to the board, preferably adjacent a rear portion of the deck. The brake may include a foot pedal coupled to a brake pad that contacts the ground in an operative condition. Such a brake may be mounted in an aperture through the deck and provided with a pivot axis and a mechanism to bias the brake to a non-operative condition.

The presently-disclosed deck may be provided with a two-segment construction with a central hinge coupling the two segments to allow for reconfiguring the skateboard between an unfolded position for riding and a folded position for carrying and stowing. A carrying handle may be provided on the skateboard, e.g., by being built into the hinge, to facilitate a user's transporting the skateboard when not in use. Preferably, the wheels are mounted alongside the deck, i.e., to the outside of right and left edges of the deck, and at different distances from the central hinge, so that the wheels do not interfere with folding the deck at the hinge.

The advantages of the present invention will be understood more readily after a consideration of the drawings and the Detailed Description.

### BRIEF DESCRIPTION OF THE DRAWINGS

FIG. 1 is a perspective view of a skateboard of the present disclosure, showing a deck that includes a hinge connecting front and rear segments, two trucks mounted beneath the deck, four wheels coupled to the trucks, and a foot-operable brake.

FIG. 2 is a side elevation of the skateboard of the present disclosure, with the near-side wheels removed to show the trucks beneath the deck and an aperture through a rear portion of the deck, through which extends an arm of the brake, and also showing a pivot axis of the hinge connecting the front and rear segments of the deck.

FIG. 3 is a side elevation similar to that of FIG. 2, with the brake illustrated in an operative condition with the pad contacting the ground.

FIG. 4 is an exploded view of the components of the deck, trucks, wheels, axles, brake, hinge, a pair of kingpins for mounting the trucks, two pairs of torsion springs for neutrally biasing the trucks, a pivot pin for the brake, and a carrying handle built into the hinge.

FIG. 5 is a partial perspective view of one end of a skateboard according to the present disclosure, showing the tilting motion of the deck producing the steering movement of the truck and wheels, and a pair of stops on the deck for limiting the steering motion of the truck.

FIG. 6 is a side view of a skateboard of the present disclosure in a folded condition, with the lower surfaces of the deck folded at the hinge towards one another and with the carrying handle deployed for hand transport, and the two pairs of wheels adjacent one another.

FIG. 7 is a perspective view from beneath the skateboard illustrating the alignment of cavities in the deck with a through hole for the kingpin.

### DETAILED DESCRIPTION

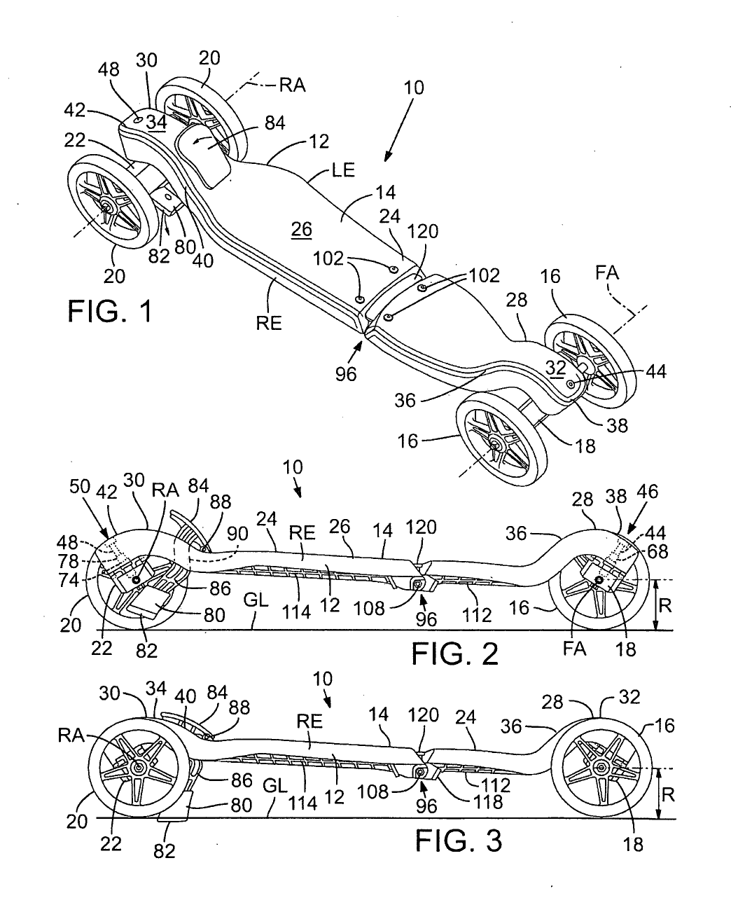

An exemplary skateboard according to the present disclosure is indicated generally at 10 in FIG. 1. A deck 12 of board 10 provides a support platform 14 for a rider or user (not shown). Deck 12 may be formed of any suitable material, e.g. molded plastic, with or without fiber or other reinforcement, or a multi-ply, laminate or other construction suited for the desired style of skateboard riding.

A pair of front wheels 16, which define a front axis of rotation FA, may be coupled to deck 12 by a front truck 18. A pair of rear wheels 20, which define a rear axis of rotation RA, may be coupled to deck 12 by a rear truck 22. Typically, wheels 16 and 20 are larger than the standard wheels of 2-inches to 4-inches in diameter used in skateboards and longboards. Although other combinations and sizes may be used, wheels 16 and 20 are typically at least about 5-inches in diameter or as large as 7-inches in diameter, or larger as suited to the particular skateboard design. Use of larger wheels typically allows a higher speed for the skateboard for a given force applied to the skateboard. Wheels 16 and 20 typically are about 1-inch wide, although other widths may be used, and thus a typical ratio of wheel diameter to width is at least about five and preferably about seven, although other sizes may be used. Wheels 16 and 20 are typically all the same size, although different combinations may be used.

The front and rear trucks may be formed of molded plastic, e.g., the same molded plastic as the deck, or formed of any other material suited to the skateboard's requirements. The wheels may be formed of any suitable material, such as polyurethane tires mounted to a plastic rim, and typically are provided with a bearing mounted in a hub.

The user typically stands on a central portion 24 of support platform 14, on an upper surface 26 of the support platform. Central portion 24 is between a front portion 28 and a rear portion 30 of support platform 14. Front portion 28 includes an upper surface 32 and rear portion 30 includes an upper surface 34. Preferably, upper surface 32 of front portion 28 and upper surface 34 of rear portion 30 are raised above upper surface 26 of central portion 24 of support platform 14. The upper surfaces of the front and rear portions may be raised, for example at their associated axes of rotation, by about 2-inches to 4-inches. Alternatively, the front and rear portions may be raised, kept level, or lowered in different combinations and to any height as suited for the desired skateboarding purpose. Upper surfaces 32, 34 of front and rear portions 28, 30 may provide a surface for the rider's feet, although in typical operation the feet would not be placed there.

Preferably, front portion 28 extends over front axis of rotation FA and rear portion 30 extends over rear axis of rotation RA. As can best be seen in FIGS. 2 and 3, raising the front and rear portions of the deck above the central portion allows the central portion to be substantially lower in elevation above a ground level GL as would otherwise be the case. Typically, upper surface 26 of central portion 24 is substantially level with at least one of the front and rear axes of rotation, and preferably upper surface 26 of central potion 24 is less than one wheel radius R above the front axis FA and rear axis RA of rotation. Alternatively, central portion 24 may be placed at any elevation relative to the front and rear axes of rotation. Upper surface 26 of central portion 24 may remain level from the front portion to the rear portion, or may be provided with a slope, such as the downward slope shown in FIGS. 2 and 3. A downward slope for the central platform tends to provide the rider with a more level platform while the rider is endeavoring to travel uphill with one foot on the deck and the other foot used to push along the ground. Also, on flat ground, the downward slope facilitates the rider's propelling the board forward because the slope allows the rider to lean forward which enhances balance and comfort during forward motion.

As may also be seen in FIGS. 1-3, front portion 28 may be designed with a curved shape including a first curvature 36 that, in a forward direction, angles upwardly from central portion 24, and a second curvature 38 that, angles downwardly. Similarly, rear portion 30 may be designed with a curved shape including a first curvature 40 that, in a rearward direction, angles upwardly from central portion 24, and a second curvature 42 that angles downwardly. It will be noted that for the embodiment of the skateboard in FIGS. 1-3, the first curvatures on the front and rear portions are placed closer to the central portion of the board than are the trucks. Preferably, second front curvature 38 and second rear curvature 42 angle downwardly at substantially equivalent, complementary angles. Alternatively, the front and rear portions may be provided with any shape as suited to a particular application.

Front truck 18 may be coupled to deck 12 adjacent front portion 28, for example, at second front curvature 38. Rear truck 22 may be coupled to deck 12 adjacent rear portion 30, for example, at second rear curvature 42. Coupling the trucks at these complementarily-angled locations provides for complementary steering of the wheels in response to the rider's tilting the deck.

For example, as best seen in FIGS. 2, 4, and 5, front truck 18 may be attached by a kingpin 44 to deck 12 at second curvature 38 of front portion 28. Kingpin 44 may be installed in a through hole 46 through the deck. Through hole 46 nay be normal to upper surface 32 at second curvature 38, in which case kingpin 44 will be offset from vertical to the same degree as second curvature 38 is angled with respect to horizontal. Such angling of kingpin 44 results in a side-to-side tilting of deck 12 being translated into a redirection of wheels 16 as will be explained more fully below.

Similarly, a rear kingpin 48 may be attached at second curvature 42 of rear portion 30 through a hole 50, typically with geometry complementary to that for the front truck. For example, both the second front curvature 38 and second rear curvature 42 may angle downwardly at about 30-degrees, providing the kingpins with an offset from vertical of about 30-degrees. Alternatively, the trucks and kingpins may be configured with different geometries as suited to a desired steering setup.

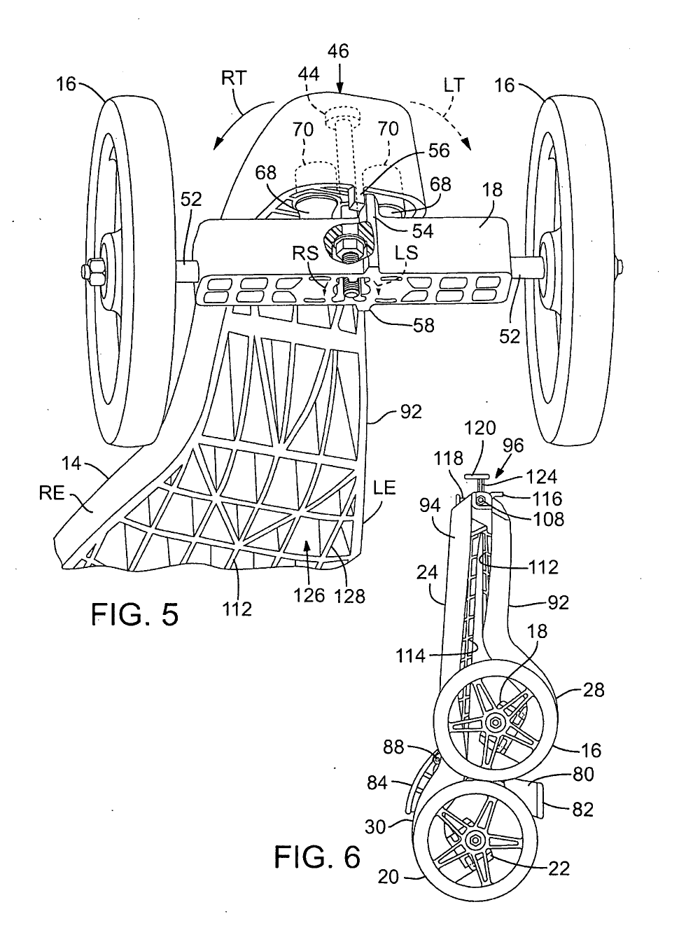

As best seen in FIG. 5, which illustrates a right hand turn with solid arrows and a left hand turn with dashed arrows, a downward tilting RT of a right edge RE of deck 12 causes a right hand steering RS of front truck 18. Similarly, a downward tilting LT of a left edge LE of deck 12 would cause a left hand steering LS of front truck 18. Typically, rear truck 22 is provided with a complementary mounting geometry that steers the rear wheels in the opposite direction of the front wheels, which tends to produce a circular path for the skateboard. Alternatively, other modes of steering may be provided, such as identically configured truck mounts for crab steering.

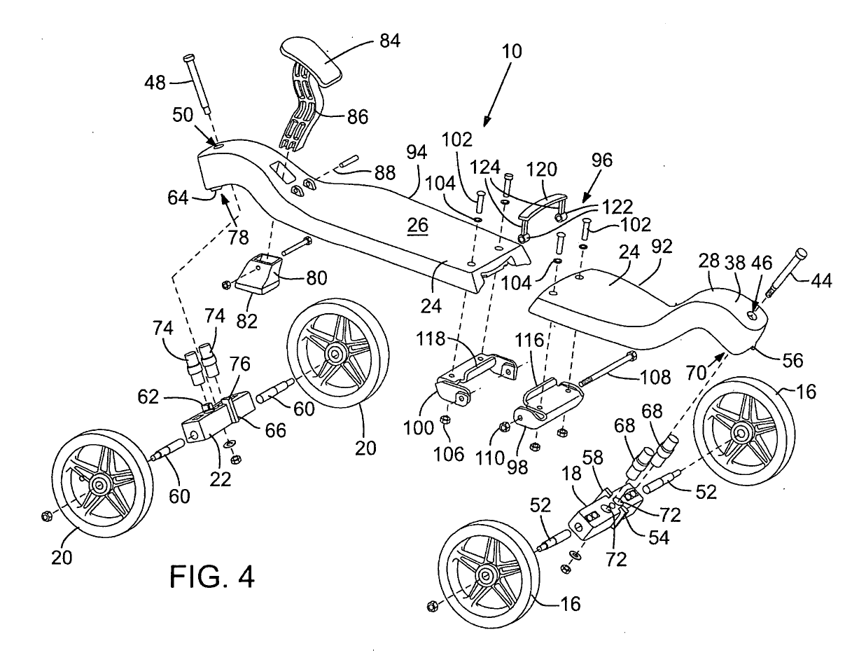

Front truck 18 may be provided with an axle, such as two-piece axle 52 and a stop 54 located adjacent the axle, for example on the front of the truck at an offset from the center of the truck, as shown in FIG. 5. Stop 54 may cooperate with a stop 56 at the front end of deck 12, e.g., at the center of the deck as shown in FIG. 5. The stops 54, 56 may cooperate to limit a divergence of the front axle from alignment with the deck, as illustrated for a right hand turn in FIG. 5. A second set of stops, including stop 58 on truck 18 may be provided in another location on truck 18 to limit, in cooperation with a stop (not shown) on deck 12, a divergence of the front axle from alignment with the deck for a left hand turn. Similarly, rear truck 22 may be provided with an axle, such as two-piece axle 60, and one or more sets of stops 62, 64, 66 for a similar limit on steering divergence of the rear truck and axle (FIG. 4).

Front truck 18 may be provided with a pair of torsion cylinders, such as springs 68 coupled to the support platform. For example, truck 18 may include a pair of cavities or pockets 70, each on one side of kingpin 44, into which one end of each torsion spring 68 is inserted. An opposing pair of pockets 72 may be provided in deck 12 adjacent front portion 28 to receive the other end of each torsion spring.

Rear truck 22 may be provided with a similar pair of torsion springs 74 and pockets 76 on the rear truck coordinated with pockets 78 in deck 12 adjacent rear portion 30. Preferably, each pair of springs 68 and 74 are arrayed substantially parallel to, and on opposite sides of the respective kingpin. Generally speaking, the torsion springs flexibly couple each axle to the deck. Alternatively, other tilt and steering control mechanisms may be provided in either or both of the front and rear portions of the deck.

Skateboard 10 may include a brake 80 mounted to support platform 14, preferably adjacent rear portion 30. Brake 80 may be foot-operated, as illustrated in FIG. 2 (in the non-operative condition) and FIG. 3 (in the operative condition). Brake 80 may include a ground-contacting pad 82, a pedal 84, an arm 86 interconnecting the arm and the pad, and a pivotal mount 88 to provide for the movement between the operative and non-operative conditions. Preferably, an aperture 90 is provided through the deck and arm 86 extends through aperture 90. Typically, the brake will also include a biasing mechanism, such as a spring (not shown) to bias the brake to the non-operative condition. Alternatively, brake 80 may be provided in a different location on support platform 14 or be differently configured for a desired riding application.

As best seen in FIGS. 4 and 6, deck 12 may be formed of more than one segment, such as front segment 92 and rear segment 94 that may be joined at a hinged portion 96. For example, front segment 92 may include front portion 28 and rear segment 94 may include rear portion 30, with central portion 24 divided between the front and rear segments.

Hinged portion 96 may include a front hinge half 98 and a rear hinge half 100, each coupled to a respective segment, e.g., by bolts 102, washers 104, and nuts 106. Hinge halves 98 and 100 may be coupled by a pin 108 fastened by a nut 110 or other hardware in a manner allowing deck 12 to fold at hinged portion 96 as shown in FIG. 6. As noted above, deck 12 defines right side edge RE and left side edge LE, and wheels 16 and 20 may be mounted outside of the side edges.

Preferably, hinged portion 96 is offset from the center of central portion 24 so that, when the deck is folded at the hinged portion, wheels 16 and 20 do not interfere with the folding, but instead are separated, or just touching, as shown in FIG. 6. In the folded position, a front underside 112 of deck 12 located in front of the hinged portion and a rear underside 114 of deck 12 located to the rear of the hinged portion may be substantially parallel to, and facing one another. Preferably, skateboard 10 is held in the unfolded position by gravity and by a pair of opposed flanges 116, 118, one on each of hinge halves 98 and 100. A latch or other means may be used to releasably fix the skateboard in either or both of the folded and unfolded positions. Preferably, only gravity holds the skateboard in the folded position.

A handle 120 for carrying the skateboard, may be provided at any convenient location on the skateboard. For example, handle 120 may be located in hinged portion 96 and may be coupled at a pair of hubs 122 on a pair of handle arms 124 to hinge pin 108. Preferably, the handle becomes accessible for carrying when deck 12 is folded at hinged portion 96, and, in a riding configuration, such as the unfolded position, handle 120 is substantially below upper surface 26 of support platform 14.

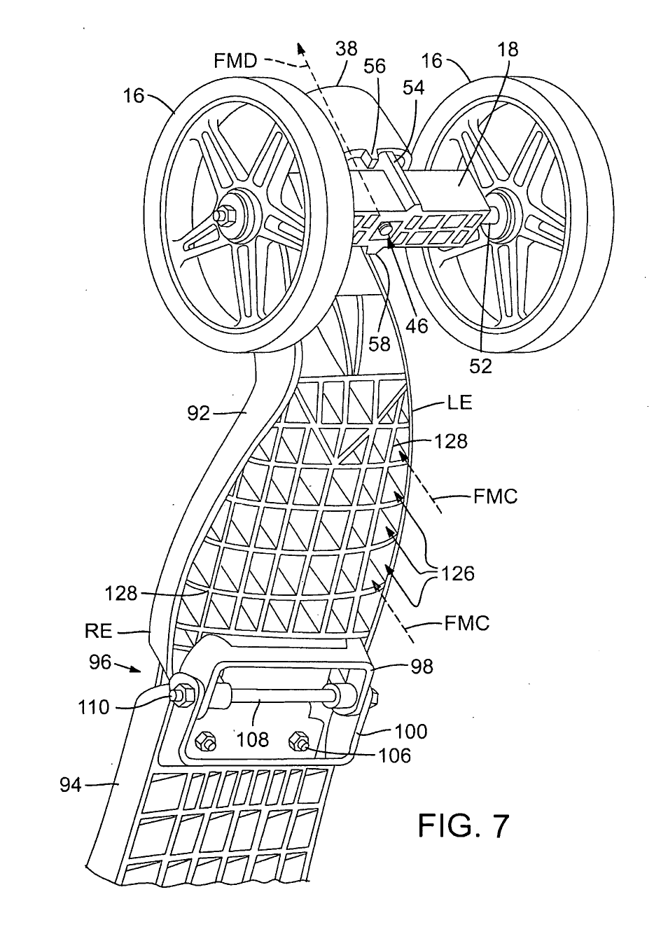

As best seen in FIG. 7, through hole 46 in front segment 92, that is configured to receive kingpin 44, may be aligned in a direction FMD that corresponds to the direction FMC of cavities 126 between ribs 128. Such alignment of the kingpin hole and the cavities facilitate molding of front segment 92 because it allows the hole and cavities to be formed between two halves of a mold and removed from the mold without a requirement for slides or other movable in-mold hardware. Rear segment 94 may be provided with a similar alignment for the kingpin hole and cavities.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where any claim recites “a” or “a first” element or the equivalent thereof, such claim should be understood to include incorporation of one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically indicated.

Inventions embodied in various combinations and subcombinations of features, functions, elements, and/or properties may be claimed through presentation of new claims in this or a related application. Such new claims, whether they are directed to a different invention or directed to the same invention, whether different, broader, narrower or equal in scope to the original claims, are also regarded as included within the subject matter of the inventions of the present disclosure. The described examples are illustrative and directed to specific examples of apparatus and/or methods rather than a specific invention, and no single feature or element, or combination thereof, is essential to all possible combinations. Thus, any one of various inventions that may be claimed based on the disclosed example or examples does not necessarily encompass all or any particular features, characteristics or combinations, unless subsequently specifically claimed.

The invention claimed is:

1. A skateboard for a user to ride, the skateboard comprising:
a deck providing a support platform for the user;
a front wheel set coupled to the deck and defining a front axis of rotation;
a rear wheel set coupled to the deck and defining a rear axis of rotation;
the support platform including a central portion defining an upper surface, a front portion defining an upper surface, and a rear portion defining an upper surface, wherein the front portion extends over the front axis of rotation and the rear portion extends over the rear axis of rotation, and further wherein the upper surface of at least one of the front and rear portions at the associated axis of rotation is raised above the upper surface of the central portion.

2. The skateboard of claim 1 wherein the upper surface of the front portion at the front axis of rotation is raised above the upper surface of the central portion and the upper surface of the rear portion at the rear axis of rotation is raised above the upper surface of the central portion.

3. The skateboard of claim 1 wherein the upper surface of the central portion is substantially level with at least one of the front and rear axes of rotation.

4. The skateboard of claim 1 wherein at least one of the front and rear portions, in a direction away from the central portion, angles upwardly from the central portion, and then, in the same direction away from the central portion, angles downwardly.

5. The skateboard of claim 4 further comprising a front truck coupling the front wheel set to the deck and a rear truck coupling the rear wheel set to the deck, and further wherein at least one of the front and rear trucks are coupled to the deck at the at least one of the front and rear portions at a location where the portion angles downwardly.

6. The skateboard of claim 4 wherein the front portion, in a forward direction, angles upwardly from the central portion, and then angles downwardly, and the rear portion, in a rearward direction, angles upwardly from the central portion, and then angles downwardly.

7. The skateboard of claim 6 wherein the front truck is coupled to the deck where the front portion angles downwardly, and the rear truck is coupled to the deck where the rear portion angles downwardly.

8. The skateboard of claim 1 wherein at least one of the front portion and the rear portion of the support platform include an upper surface that is at least about 2-inches above the upper surface of the support platform.

9. The skateboard of claim 1 further including a front truck mounted under the front portion of the support platform and a rear truck mounted under the rear portion of the support platform.

10. The skateboard of claim 9 wherein at least one of the front and rear trucks includes a pair of torsion springs coupled to the support platform.

11. The skateboard of claim 1 further including a brake mounted to the rear portion of the support platform.

12. The skateboard of claim 11 wherein the brake is foot-operated.

13. The skateboard of claim 11 wherein the brake includes a ground-contacting pad.

14. The skateboard of claim 1 wherein the support platform slopes downwardly from adjacent the rear wheel set toward the front wheel set.

15. The skateboard of claim 1 wherein the front and rear wheels sets include wheels having a diameter of at least about 5-inches.

16. The skateboard of claim 1 wherein the front and rear wheels define a diameter and a width and wherein the ratio of diameter to width of at least one wheel is at least about 5.

17. A skateboard for a user to ride, the skateboard comprising:
a deck providing a support platform for the user;
a front truck coupling the deck to a front wheel set, the front truck including a front kingpin coupling the deck to a front wheel axle and a pair of torsion cylinders arrayed substantially parallel to, and on opposite sides of the front kingpin, the torsion cylinders flexibly coupling the front axle to the deck; and
a rear truck coupling the deck to a rear wheel set, the rear truck including a rear kingpin coupling the deck to a rear wheel axle and a pair of torsion cylinders arrayed substantially parallel to, and on opposite sides of the rear kingpin, the torsion cylinders flexibly coupling the rear axle to the deck.

18. The skateboard deck of claim 17 further including a stop located adjacent the front axle limiting a divergence of the front axle from alignment with the deck.

19. The skateboard deck of claim 17 further including a stop located adjacent the rear axle limiting a divergence of the rear axle from alignment with the deck.

20. The skateboard deck of claim 17 wherein the support platform further includes a central portion including an upper surface that is substantially level with the front and rear axles.

21. The skateboard deck of claim 17 wherein the support platform further includes a front portion rising above the central portion for coupling to the front truck and a rear portion rising above the central portion for coupling to the rear truck.

22. The skateboard deck of claim 17 wherein at least one of the front and rear trucks are formed of molded plastic.

23. The skateboard deck of claim 22 wherein the at least one of the front and rear trucks includes a pair of pockets, each pocket receiving an end of one of the torsion cylinders.

24. The skateboard deck of claim 17 wherein at least one of the front and rear kingpins are tilted from vertical by about 30-degrees.

25. The skateboard deck of claim 24 wherein the tilted kingpin is mounted to a portion of the support platform that is tilted from horizontal by substantially the same angle as the kingpin is tilted from vertical.

26. A skateboard for a user to ride, the skateboard comprising:
a deck providing a support platform for the user, the deck including a hinged portion located between a front portion and a rear portion;
a pair of front wheels mounted to a front axle and a pair of rear wheels mounted to a rear axle, the axles coupled to the deck; and
a handle for carrying the skateboard, the handle located in the hinged portion of the deck, the handle accessible for carrying when the deck is folded at the hinged portion.

27. The skateboard of claim 26 wherein the deck defines right and left side edges and wherein the wheels are mounted outside of the side edges.

28. The skateboard of claim 26 wherein the deck includes a front underside located in front of the hinged portion and a rear underside located to the rear of the hinged portion, and wherein the front underside and rear underside are substantially parallel to and facing one another when the deck is folded at the hinged portion.

29. The skateboard of claim 26 wherein the handle in a riding configuration of the skateboard is substantially below an upper surface of the support platform.

30. The skateboard of claim 29 wherein the front and rear portions of the support platform are raised relative to the hinged portion, and further including a front truck mounted under the front portion of the support platform and a rear truck mounted under the rear portion.

31. The skateboard of claim 30 wherein at least one of the trucks is located higher than an underside of the deck.

32. The skateboard of claim 26 wherein the deck is molded in a front segment that includes the front portion and a rear segment that includes the rear portion, wherein at least one of the front and rear segments includes a through hole configured to receive a kingpin, the through hole aligned in a direction, and further wherein the at least one segment includes at least one cavity aligned in substantially the same direction of the through hole.

33. The skateboard of claim 26 further comprising a foot-operated brake mounted to the deck.

34. The skateboard of claim 26 wherein at least one pair of the pair of front wheels and the pair of rear wheels have a diameter of at least about 5 inches.

35. A skateboard for a user to ride, the skateboard comprising:
a deck providing a support platform for the user, the support platform including a central portion and a rear portion, and wherein the rear portion is angled upwardly with respect to the central portion;
a front wheel set coupled to the deck adjacent a front portion of the support platform;
a rear wheel set coupled to the deck adjacent the rear portion of the support platform; and
a brake mounted to the deck where the rear portion angles upwardly, the brake including a foot-operated pedal and a pad configured to contact the ground when the pedal is operated.

36. The skateboard of claim 35 wherein the brake includes a hinge mounted to the support platform for rotating the brake between a non-operative and an operative position.

37. The skateboard of claim 35 wherein an aperture is provided through the deck, and wherein the brake includes a portion that extends through the aperture.
